(19) United States
(12) Patent Application Publication
(10) Pub. No.: US 2026/0329789 A1
(43) Pub. Date: Oct. 22, 2026

(54) YANG SCHEMA-DRIVEN PROTOBUF SERIALIZATION METHOD

(71) Applicant: Hewlett Packard Enterprise Development LP, Spring, TX (US)

(72) Inventors: Yanmin Liu, Beijing (CN); Guo Xiao, Beijing (CN)

(21) Appl. No.: 19/181,023

(22) Filed: Apr. 16, 2025

(51) Int. Cl. G06F 13/36

(52) U.S. Cl. CPC G06F 13/36; G06F 2213/24

(57) ABSTRACT

A system, by a network device, loads a current Yet Another Next Generation (YANG) schema comprising an external data model that defines a structure of data to be used in configuring the network device, the external data model associated with a hierarchical structure. The system creates a first mapping of elements of the external data model to elements of an internal data model native to the network device. The system creates a second mapping of the elements of the external data model to Protocol Buffers (Protobuf) data structures. The system extracts the data from a database by traversing the hierarchical structure associated with the external data model based on the first mapping and the second mapping. The system obtains a Protobuf-formatted message by encoding the extracted data directly into serialized bytes while obviating compilation of the current YANG schema to a Protobuf descriptor file and to the Protobuf-formatted message.

### BACKGROUND

Yet Another Next Generation (YANG) language can be used to define YANG schemas, which are data models that describe the structure and types of data employed in configuring and managing network devices. Protocol Buffers (Protobuf) can serve as a data format for serializing structured data, often facilitating communication between network devices and centralized systems. Traditionally, solutions have relied on statically defined YANG schemas, which are compiled into Protobuf descriptor files. These descriptor files are then either compiled into source code files or dynamically loaded into a serializer to obtain a Protobuf-formatted message with serialized bytes. However, this approach faces challenges in environments where data models evolve frequently, such as in telemetry data management where various YANG models may be employed. Current methods necessitate costly compilation processes each time a new or updated model is introduced, leading to increased complexity and slower processing times.

### BRIEF DESCRIPTION OF THE FIGURES

FIG. 1 illustrates a diagram depicting a high-level overview of a system which facilitates a YANG schema-driven Protobuf serialization method, in accordance with an aspect of the present application.

FIG. 2 illustrates a diagram depicting communications for negotiating a YANG schema between a network device and a network management station, in accordance with an aspect of the present application.

FIG. 3A presents a flowchart illustrating a method for loading a YANG schema, in accordance with an aspect of the present application.

FIG. 3B illustrates a diagram with a “second mapping” of elements of an external data model to Protobuf data structures, in accordance with an aspect of the present application.

FIG. 4A presents a flowchart illustrating a method for traversing a hierarchical structure and encoding data as serialized bytes assigned or appended to a Protobuf-formatted message, in accordance with an aspect of the present application.

FIG. 4B presents a post-order traversal of a sample hierarchical structure, in accordance with an aspect of the present application.

FIG. 5 presents a flowchart illustrating a method which facilitates a YANG schema-driven Protobuf serialization method, in accordance with an aspect of the present application.

FIG. 6 illustrates a computer system which facilitates a YANG schema-driven Protobuf serialization method, in accordance with an aspect of the present application.

FIG. 7 illustrates a computer-readable medium which facilitates a YANG schema-driven Protobuf serialization method, in accordance with an aspect of the present application.

In the figures, like reference numerals refer to the same figure elements.

### DETAILED DESCRIPTION

Aspects of the present application provide a system which facilitates a system and method serializing YANG schemas directly into Protobuf messages while eliminating the need for intermediate compilation into Protobuf descriptor files or Protobuf messages.

Yet Another Next Generation (YANG) language can be used to define YANG schemas, which are data models that describe the structure and types of data employed in configuring and managing network devices. Protocol Buffers (Protobuf) can serve as a data format for serializing structured data, often facilitating communication between network devices and centralized systems. Traditionally, solutions have relied on statically defined YANG schemas, which are compiled into Protobuf descriptor files. These descriptor files are then either compiled into source code files or dynamically loaded into a serializer, which converts complex data structures into a linear, portable format suitable for storage and transmission.

However, this approach faces challenges in environments where data models evolve frequently, such as in telemetry data management where various YANG models may be employed. Current methods necessitate costly compilation processes each time a new or updated model is introduced, leading to increased complexity and slower processing times.

The described aspects provide a solution to the above-described challenges by allowing a network device to dynamically adapt at runtime to changes in multiple YANG schemas, which can support real-time updates to YANG schemas. This can be particularly important in telemetry data management systems, where schema changes may occur frequently. The described aspects can circumvent the need for static compilation required in traditional solutions by creating a mapping between YANG schema elements and Protobuf structures, resulting in efficient Protobuf serialization. Essentially, the described aspects can directly serialize data into the Protobuf format based on the dynamic YANG schema, eliminating the need for intermediate steps and compilation of the YANG schema to the Protobuf descriptor file. This approach can significantly enhance flexibility and efficiency in handling evolving network data models.

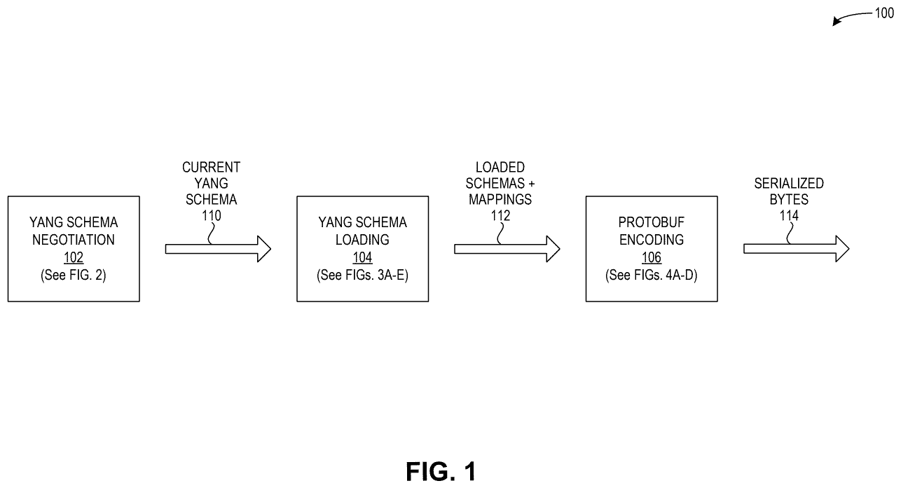

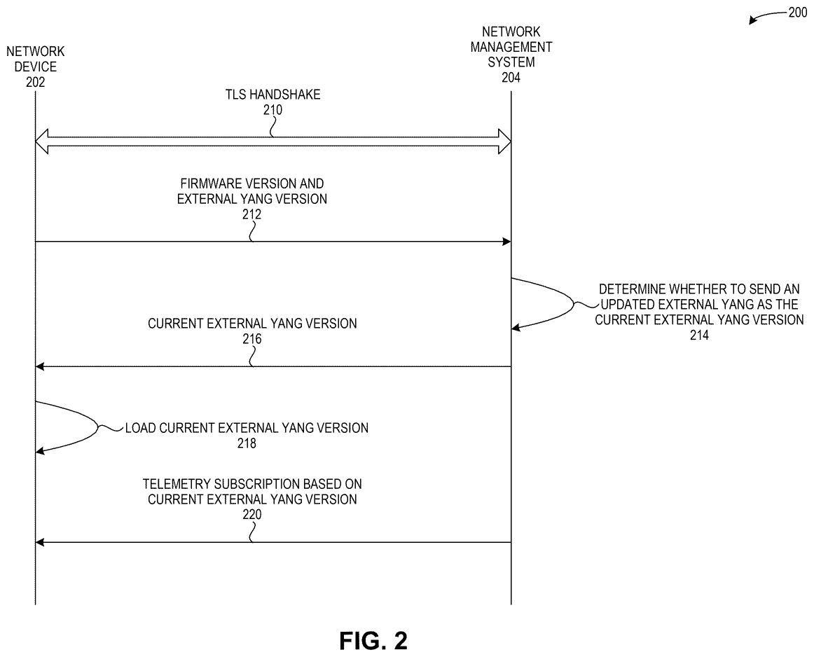

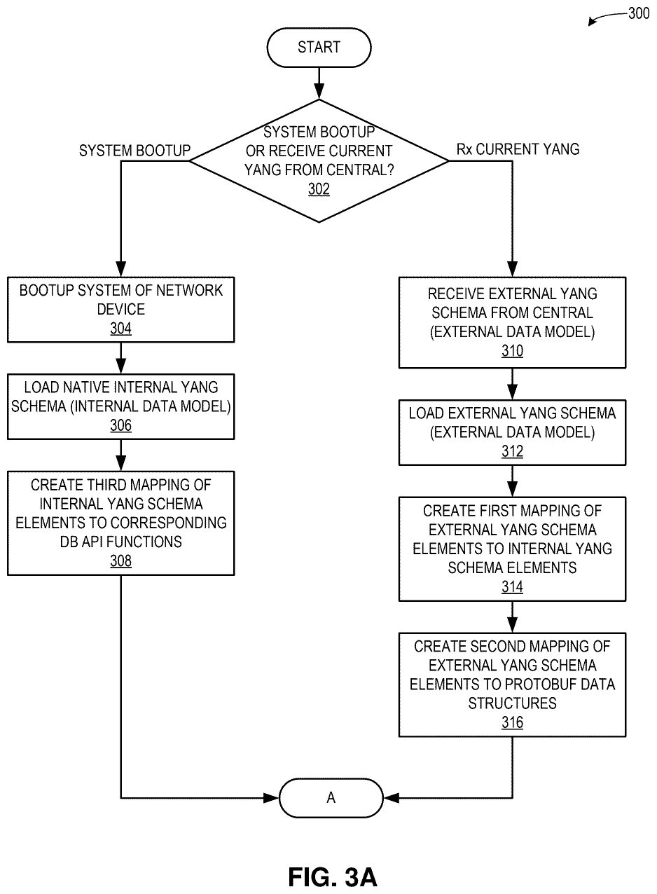

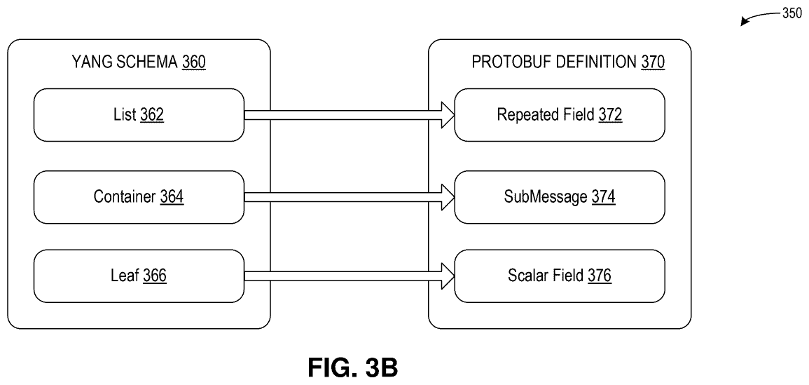

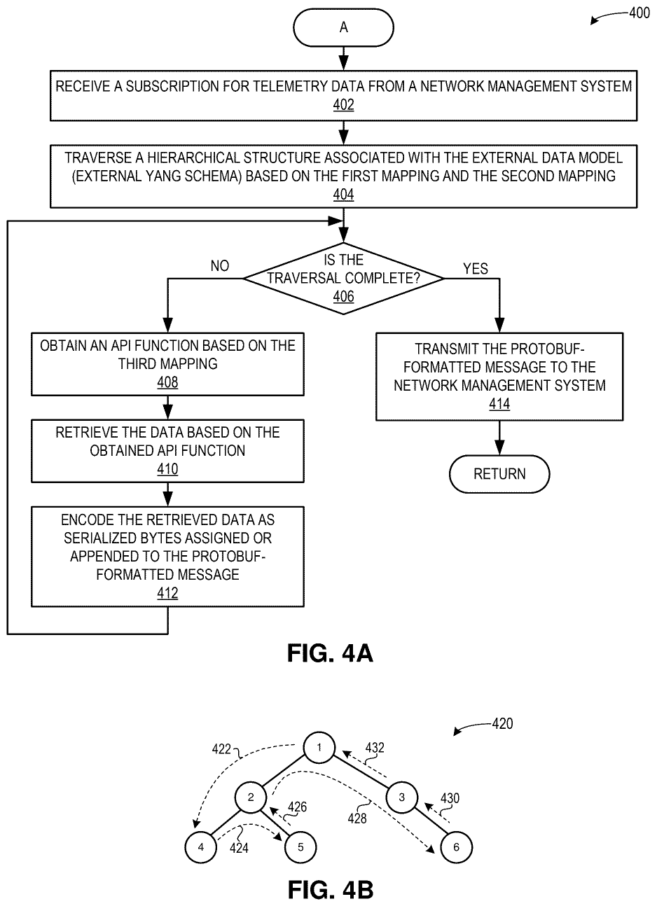

FIG. 1 illustrates a diagram 100 depicting a high-level overview of a system which facilitates a YANG schema-driven Protobuf serialization method, in accordance with an aspect of the present application. Diagram 100 can include three major modules or actions (102, 104, and 106). A network device and a network management station (NMS) (also referred to as “central management station” or “Central”) can communicate and perform a YANG schema negotiation 102, which can result in the network device dynamically obtaining a current YANG schema (as described below in relation to FIG. 2). This current YANG schema may be passed as an input 110 to a YANG schema loading 104, in which the network device loads the current YANG schema (as the external data model) and also loads an internal data model. As part of YANG schema loading 104, the network device may create three different mappings, based on the internal data model, the external data model, Protobuf data structures, and database APIs (as described below in relation to FIGS. 3A-E). The loaded schemas and created mappings may be passed as an input 112 to a Protobuf encoding 106, in which the network device extracts data by traversing a hierarchical structure associated with the external data model based on the mappings and obtains a Protobuf-formatted message by encoding the extracted data directly into serialized bytes of the Protobuf-formatted message (as described below in relation to FIGS. 4A-D). By encoding data directly into the serialized bytes, the network device can eliminate the costly compilation of the current YANG schema to a Protobuf-descriptor file and to the Protobuf-formatted message required by the current solutions. As described above, the described aspects can significantly enhance flexibility and efficiency in handling evolving network data models.

FIG. 2 illustrates a diagram 200 depicting communications for negotiating a YANG schema between a network device 202 and a network management system (NMS) 204, in accordance with an aspect of the present application. NMS 204 can store centrally defined and updated YANG schemas, which can ensure that the YANG schema used by the associated or connected network devices (e.g., network device 202) is always up to date.

Network device 202 and NMS 204 can communicate and establish a secure communication channel, e.g., based on a Transport Layer (TLS) handshake 210. Network device 202 may send to NMS 204 its firmware version and the version of its external YANG schema (via a communication 212). NMS 204 may determine whether or not to send an updated external YANG schema as the current external YANG version (operation 214). NMS 204 may make this determination based on a comparison of the information from network device 202 of the received external YANG version and its own information about the current external YANG version. This determination or comparison can allow network device 202 to dynamically obtain the most updated or current version of the external YANG schema.

NMS 204 can send the current external YANG version back to network device 202 (as a communication 216). Network device 202 can load the current external YANG version (operation 218). Loading a YANG schema is described below in relation to FIGS. 3A-E. In addition, NMS 204 may send, and network device 202 may receive, a telemetry subscription based on the current external YANG version (as a communication 220). Responding to a telemetry subscription by encoding data into serialized bytes of a Protobuf-formatted message is described below in relation to FIGS. 4A-D.

Changes or updates may be made to YANG schemas stored and maintained by NMS 204. Examples of such changes or updates can be related to, e.g., new features, bug fixes, or adjustments in the data model. NMS 204 may detect such changes or updates and send a push notification (not shown in FIG. 2) to network device 202 indicating that a new (or updated or current) YANG schema is available. In response to receiving the push notification from NMS 204, network device 202 can initiate a real-time negotiation process with NMS 204, as described above in relation to communications/operations 212, 214, 216, and 218. As a result, NMS 204 may serve as the authoritative source of the current YANG schema for the associated or connected network devices (e.g., network device 202).

FIG. 3A presents a flowchart 300 illustrating a method for loading a YANG schema, in accordance with an aspect of the present application. The system (i.e., a network device) determines whether a system bootup occurs or if the network device receives a current YANG schema from a network management station (Central) (decision 302). If the system bootup occurs (decision 302), the network device performs a bootup of its system (operation 304) and loads a native internal YANG schema (internal data model) (operation 306). The internal YANG schema may be an internal data model that defines a structure of data to be used in configuring the network device. A hierarchical structure may be associated with the internal YANG schema, as described below in relation to the internal data model and the external data model. The network device creates a “third mapping” of elements of the internal YANG schema to corresponding database API functions (operation 308). The network device may subsequently use this third mapping, along with other mappings, to retrieve data based on a specific API function. A sample third mapping of elements of an internal data model to database API functions is described below in relation to Table 2. The database may be any known database, e.g., Redis. The operation continues at Label A of FIG. 4A.

If the network device receives a current YANG schema from the network management system (decision 302), the network device receives the external data model from Central (operation 310) and loads this external YANG schema (external data model) (operation 312). The external data model may be associated with a hierarchical structure (such as a tree). The network device creates a “first mapping” of elements of the external data model to elements of the internal data model (which was loaded in operation 306) (operation 314). This first mapping may be based on a same YANG extension included in both the internal data model and the external data model, as described below in relation to the “yang-ext” elements.

The network device also creates a “second mapping” of the elements of the external data model to Protobuf data structures (operation 316). The network device may use the first mapping and the second mapping together to determine (based on the first mapping) the corresponding internal YANG element for an external YANG element and to subsequently determine (based on the second mapping) the exact Protobuf data structure which corresponds to the external YANG element. In addition, the network device may determine (based on the third mapping created in operation 308) a corresponding database API function or call for each internal YANG element. The network device can subsequently call the corresponding API function to retrieve or obtain the indicated data. The operation continues at Label A of FIG. 4A.

A sample internal data model may be indicated by the following:

```
module internal-client-model {
  namespace “http://example.com/internal-client”;
  container state {
    list client-info {
      key “client-id”;
      yang-ext:db-prefix “/state/client-info”
      leaf client-id {
        type string;
      }
      leaf client-name {
        type string;
      }
      leaf ip-address {
        type inet:ipv4-address;
      }
      leaf mac-address {
        type string;
      }
      leaf connection_status {
        type enumeration {
          enum connected;
          enum disconnected;
        }
      }
      leaf last_active_time {
        type uint64; // Timestamp in seconds
      }
      leaf client_type {
        type enumeration {
          enum mobile;
          enum laptop;
          enum iot;
        }
      }
    }
  }
}
```

Additionally, a sample external model may be indicated by the following:

```
module external-client-model {
    namespace “http://example.com/external-client”;
    prefix “ext”;
    container state {
        list client-info {
          key “client-id”;
            yang-ext:source “/state/client-info”
          leaf client-id {
            type string;
          }
          leaf client-name {
            type string;
          }
          leaf ip-address {
            type inet:ipv4-address;
          }
          leaf mac-address {
            type string;
          }
      }
  }
}
```

Each of the above models can define a module and include a namespace. In addition, each of the above models may define a structure for a list entitled “client-info” with the key “client-id” and a specific same YANG extension which may be used to identify the location of the data to be extracted. For example, the internal data model may use a YANG extension of <yang-ext: db-prefix “state/client-info”>, which can identify the location of the data to be extracted based on the internal data model. The internal data model can also define, as part of the container entitled “state,” several leaves, including: a client-id; a client-name; an Internet Protocol (IP)-address; a Media Access Control (MAC)-address; a connection status; a last active time; and a client type.

The external data model may also use a similar YANG extension of “<yang-ext: source “state/client-info”>, which can identify the location of the data to be extracted based on the external data model. As in the internal data model, the external data model may also define, as part of the container entitled “state,” several leaves, including: a client-id; a client-name; an IP-address; and a MAC-address. A network device may use the elements defined in each of these models to create the first mapping, as described below in relation to Table 1.

Table 1 illustrates a “first mapping” of elements of an external data model to elements of an internal data model:

TABLE 1

| External YANG | Internal YANG | Des- |
|---|---|---|
| Schema Xpath | Schema Xpath | cription |
| /external-client-model:state/ | /internal-client-model:clients/ | Unique |
| client-info/client-id | client/id | client id |
| /external-client-model:state/ | /internal-client-model:clients/ | Client |
| client-info/client-name | client/name | name |
| /external-client-model:state/ | /internal-client-model:clients/ | IPv4 |
| client-info/ip-address | client/ip | address |
| /external-client-model:state/ | /internal-client-model:clients/ | MAC |
| client-info/mac-address | client/mac | address |

Table 1 can include rows with the following fields: an external YANG schema Extensible Markup Language (XML) Path (xPath); an internal YANG schema xPath; and a description. xPath is a syntax that can be used for defining or navigating through part of an XML document. As an example, the first row in Table 1 can indicate that the external YANG schema xPath element at “/external-client-model: state/client-info/client-id” is mapped to the internal YANG schema xPath element at “/internal-client-model: clients/client/id,” and that the description of these elements and the mapping between these elements is that of “unique client id.” The remaining rows can indicate a similar mapping for, respectively, the client name, the IPV4 address, and the MAC address.

FIG. 3B illustrates a diagram 350 with a “second mapping” of elements of an external data model to Protobuf data structures, in accordance with an aspect of the present application. In diagram 350, the external data model is illustrated by a YANG schema 360 and the Protobuf data structures are indicated by a Protobuf definition 370. A list 362 element in YANG schema 360 can be mapped to a repeated field 372 in Protobuf definition 370; a container 364 element in YANG schema 360 can be mapped to a SubMessage 374 in Protobuf definition 370; and a leaf 366 element in YANG schema 360 can be mapped to a scalar field 376 in Protobuf definition 370. This “second” mapping indicated in diagram 350 can result in a seamless integration between a YANG schema and a Protobuf-formatted message.

Table 2 illustrates a “third mapping” of elements of an internal data model to corresponding database Application Programming Interface (API) functions, in accordance with an aspect of the present application.

TABLE 2

| Internal YANG | Database | Operation |
|---|---|---|
| Schema Xpath | API Function | Type |
| /internal-client-model:clients/ | set_client_id(client_id) | Write (SET) |
| client/id | | |
| /internal-client-model:clients/ | get_client_id( ) | Read (GET) |
| client/id | | |
| /internal-client-model:clients/ | set_client_name(name) | Write (SET) |
| client/name | | |
| /internal-client-model:clients/ | get_client_name( ) | Read (GET) |
| client/name | | |
| /internal-client-model:clients/ | set_client_ip(ip) | Write (SET) |
| client/ip | | |
| /internal-client-model:clients/ | get_client_ip( ) | Read (GET ) |
| client/ip | | |
| /internal-client-model:clients/ | set_client_mac(mac) | Write (SET) |
| client/mac | | |
| /internal-client-model:clients/ | get_client_mac( ) | Read (GET) |
| client/mac | | |

Table 2 can include rows with the following fields: an internal YANG schema xPath; a corresponding database API function; and an operation type which describes the API function. For example: the first two indicate that, for the internal YANG schema xPath element at “/internal-client-model: clients/client/id,” the corresponding database API function for setting or writing that element is “set_client_id(client_id)” with an operation type of “Write (SET),” and the corresponding database API function for getting or retrieving that same element is “get_client_id( )” with an operation type of “Read (GET).” Similarly, the remaining pairs of rows can indicate the same mapping for the Write and Read database API functions for, respectively, the client name, the IPV4 address, and the MAC address.

FIG. 4A presents a flowchart 400 illustrating a method for traversing a hierarchical structure and encoding data as serialized bytes assigned or appended to a Protobuf-formatted message, in accordance with an aspect of the present application. At Label A (continuing from Label A in FIG. 3A), the network device has negotiated and dynamically received the most recent YANG schema and has also loaded the current YANG schema and created the mappings (as described above in relation to FIGS. 2 and 3A-E). The network device receives a subscription for telemetry data from a network management system (e.g., Central) (operation 402). The subscription may indicate telemetry data, such as a requested interval for receiving data reports, a data aggregation policy, the types of data requested, etc.

The network device traverses a hierarchical structure associated with the external data model (i.e., the current external YANG schema) based on the first mapping and the second mapping (operation 404). The hierarchical structure may be represented by a tree, and each node in the tree may correspond to a specific data element in the current external YANG schema, such as a container, a list, or a leaf. Each node may hold values which need to be serialized as part of the Protobuf serialization method described herein. The network device may process each node based on its type as defined in the YANG schema. For containers, the network device can recursively traverse the child elements of a container, thus ensuring that all nested data structures can be accurately encoded. For lists, the network device can iterate over each entry in a respective list. An example of performing a post-order traversal on a tree is described below in relation to FIG. 4B.

If the traversal is not complete (decision 406), the system obtains an API function based on the third mapping (operation 408). For example, if a node to be processed corresponds to or is defined as a leaf in the current external YANG schema, the system may determine the corresponding database API function for that leaf (e.g., one of the Write or Read operation types as described above in relation to Table 2). The network device retrieves the data from a database based on the obtained API function (operation 410). For example, the network device may determine that a leaf corresponds to an external xPath which is mapped to an internal xPath, as in the first row of Table 1 (i.e., from the first mapping), and the network device may further determine that the internal xPath corresponds to a “Write” or “SET” database API function of “set_client_id(client_id)” as in the top row of Table 2 (i.e., based on the third mapping).

The system encodes the retrieved data as serialized bytes assigned or appended to the Protobuf-formatted message (operation 412). For example, the system may call a function such as “encode_yang_to_proto” and pass in the node, database, and parent key. This function may create the Protobuf message, encode each node in the YANG tree, and return serialized bytes based on the Protobuf-formatted message. As described above, the network device may use a recursive function (e.g., “encode_yang_node”) to encode all YANG nodes into the Protobuf-formatted message. The network device can also convert the value obtained from the recursive encoding of each node into a corresponding Protobuf type (based on, e.g., the second mapping described above in relation to FIG. 3B). An example of pseudocode which can perform the above-described steps is described below.

After encoding the retrieved data, the network device again determines whether the traversal is complete (decision 406). If it is not, the operation continues as described above for operations 408-412. That is, the network device can perform operations 408-412 iteratively prior to completing the traversal. If the traversal is complete (decision 406), the network device transmits the Protobuf-formatted message (i.e., the serialized bytes) to the network management system (operation 414). The operation returns.

FIG. 4B presents a post-order traversal of a sample hierarchical structure 420 (e.g., a tree), in accordance with an aspect of the present application. A network device may perform a post-order traversal, e.g., by performing a depth-first search and visiting the left subtree, then the right subtree, and lastly the root node. That is, the network device can recursively traverse the left subtree, then recursively traverse the right subtree, and finally visit the root node after all its child nodes (in the left and right subtrees) have been visited. In sample tree 420, the post-order traversal can start from root node 1 and move (422) to node 4, which is a single left-most leaf in its subtree. The leaf nature of node 4 may be inferred by the Protobuf data structure definitions mapped to the external YANG schema elements in the second mapping, as described above in relation to FIG. 3B. For each field, the network device can determine the identifier and the type, which information is maintained by the second mapping. The network device can determine the value corresponding to the field or node based on the first and second mappings. The network device may use the identifier, type, and value to serialize the data corresponding to node 4 and, based on the mappings, encode the data into the Protobuf format (i.e., serialized bytes of a Protobuf-formatted message). During the encoding, the network device may serialize the identifier, type, and value in one sequence of bytes. The network device can subsequently move (424) on to the right subtree at node 5 and perform the same encoding of the data indicated by node 5 into serialized bytes of a Protobuf-formatted message. The network device can subsequently move (426) to node 2, which is the root node for subtrees represented by nodes 4 and 5. The network device can continue to traverse tree 420 using a post-order traversal (i.e., depth-first), visit each node, and encode the data associated with each node into serialized bytes of a Protobuf-formatted message: moving (428) from node 2 to node 6; moving (430) from node 6 to node 3; and finally moving (432) from node 3 to the final root node 1.

The pseudocode described below can perform the above-described steps for encoding the retrieved data as serialized bytes, i.e., encoding a YANG schema to a Protobuf message. The below pseudocode includes a recursive function which encodes YANG nodes into the Protobuf message:

```
function encode_yang_to_proto(yang_node, database, parent_key=“”) :
  proto_message = create_proto_message( ) # Create empty Protobuf msg
  encode_yang_node(yang_node, proto_message, database, parent_key)
  return protobuf_serialize(proto_message) # Serialize to bytes
# Recursive function to encode YANG nodes into a Protobuf msg
function encode_yang_node(yang_node, proto_message, database,
parent_key) :
  node_key = generate_key(parent_key, yang_node) # Generate DB key
  if yang_node.type == “container”:
    for child in yang_node.children:
      encode_yang_node(child, proto_message, database, node_key)
  else if yang_node.type == “list”:
    list_instances = database.get_list_instances(node_key)
    # Retrieve list instances
    for item in list_instances:
      list_entry = proto_message.add(yang_node.name)
      # Add a new list entry
      encode_yang_node(item, list_entry, database, node_key)
  else if yang_node.type == “leaf”:
    value = database.get(node_key) # Fetch value from DB
    if value is not None:
      encoded_value = encode_leaf(yang_node, value)
      # Convert to Protobuf type
      proto_message.set(yang_node.name, encoded_value)
      # Assign to Protobuf message
  else if yang_node.type == “leaf-list”:
    values = database.get_list(node_key)
    # Retrieve all values of the leaf-list
    for value in values:
      encoded_value = encode_leaf(yang_node, value)
      # Convert to Protobuf type
      proto_message.append(yang_node.name, encoded_value)
      # Append to Protobuf list field
```

As indicated by the above pseudocode, the function “encode_yang_to_proto” can take as input a specific YANG node (“yang_node”), a database (“database”) from which to retrieve data, and a parent key (“parent_key” which may have an empty value when initially calling this function). The function “encode_yang_to_proto” can first create an empty Protobuf message, call the function encode_yang_node, and return a sequence of serialized bytes as a Protobuf-formatted message.

Additionally, the above pseudocode indicates the recursive function which encodes YANG nodes into the serialized bytes of the Protobuf-formatted message. The function “encode_yang_node” can take as input the specific YANG node (“yang_node”), the current Protobuf-formatted message (“proto_message”), the database (“database”) from which to set or get data, and the parent key (“parent_key”) which indicates a parent of the leaf or node currently being encoded. This function first generates a node key (“node_key”) which is a database key generated and used to retrieve values from the database.

The above pseudocode can include a cascading IF-ELSE IF structure for various types of YANG nodes, beginning with handling a “container” type and moving on to handle a “list” type, a “leaf” type, and a “leaf-list” type. If the node type is a container, the function can recursively perform the “encode_yang_node” function on all children of that node. Otherwise, if the node type is a list, the function can retrieve all instances of the list and iterate through each item in the list instances and perform the “encode_yang_node” function on each item. Otherwise, if the node type is a leaf, the function can retrieve the value from the database, and if the value is not an empty value, the function can perform an “encode_leaf” function which converts the element to a Protobuf data structure and assigns the encoded value to the Protobuf-formatted message. Otherwise, if the node type is a leaf-list, the function retrieves all values of the leaf-list and can perform the “encode_leaf” function on each of the retrieved values, which converts the element to a Protobuf data structure and appends the encoded value to the Protobuf-formatted message.

Furthermore, the pseudocode below can generate a hierarchical database keys, convert a YANG leaf value to a corresponding Protobuf type, and execute a call to obtain the serialized output:

```
# Helper function to generate hierarchical database keys
function generate_key(parent_key, yang_node) :
  if parent_key == “”;
    return yang_node.name
  else:
    return parent_key + “/” + yang_node.name
    # Construct hierarchical key
# Convert YANG leaf value to the corresponding Protobuf type
function encode_leaf(yang_node, value) :
  if yang_node.data_type == “string”:
    return value
  else if yang_node.data_type == “int32”:
    return int(value)
  else if yang_node.data_type == “uint32”:
    return unsigned_int(value)
  else if yang_node.data_type == “bool”:
    return (value == “true”)
  else if yang_node.data_type == “ipv4-address”:
    return encode_ip_address(value)
  else:
    return value # Default case
# Example Execution
yang_root = load_yang_data( ) # Load YANG tree structure
database = Database( ) # Assume a database instance
serialized_bytes = encode_yang_to_proto(yang_root, database)
# Get serialized output
```

The helper function can generate hierarchical database keys. The function “generate_key” can take as input the parent key (“parent_key”) and the specific YANG node (“yang_node”) and return a hierarchical key which identifies where the specific YANG node falls in the hierarchical data structure associated with the given data model.

The function “encode_leaf” can convert a YANG element leaf value to the corresponding Protobuf data structure or type. The function “encode_leaf” can take as input the specific YANG node (“yang_node”) and the corresponding value (“value”). This function can return the type of value as the specified type, e.g.: if the type of the YANG node is a “string,” the function returns the value; if the type of the YANG node is an “int32,” the function returns the value as an integer; etc.

The example execution illustrates how to obtain, from a YANG schema, the final serialized bytes as a Protobuf-formatted message. The example execution sets the “yang_root” by loading the YANG tree structure (based on the first and second mappings) and also sets a “database” instance. The final serialized output of “serialized bytes” can be the result of calling the “encode_yang_to_proto” function, which calls the recursive function “encode_yang_node” on all nodes in the YANG tree in a post-order traversal (i.e., depth-first) manner.

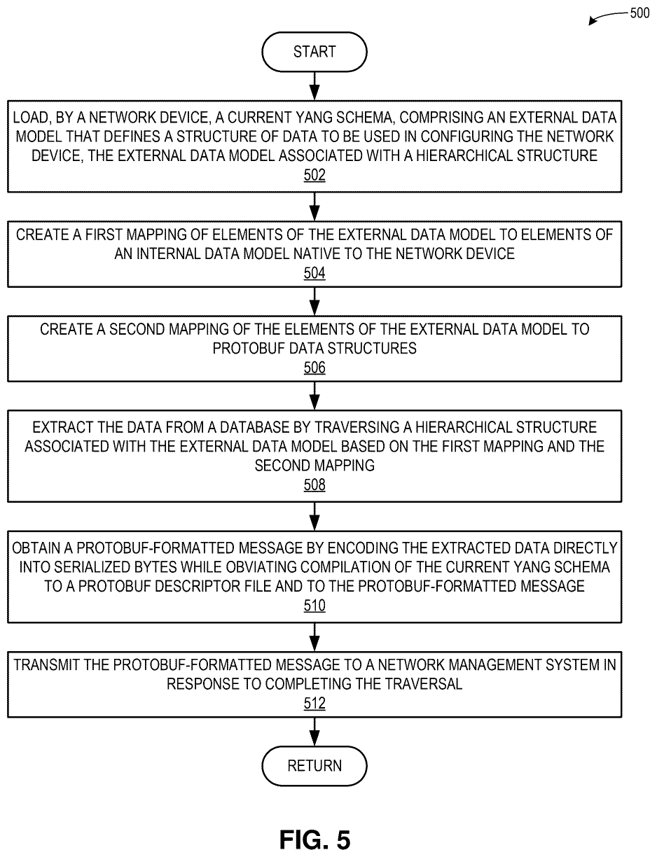

FIG. 5 presents a flowchart 500 illustrating a method which facilitates a YANG schema-driven Protobuf serialization method, in accordance with an aspect of the present application. The system loads, by a network device, a current YANG schema comprising an external data model that defines a structure of data to be used in configuring the network device, the external data model associated with a hierarchical structure (operation 502). The network device may perform a YANG schema negotiation with a network management system (NMS) to obtain the most current YANG schema, as described above in relation to the communications between network device 202 and NMS 204 in FIG. 2. The network device may load the external YANG schema, e.g., the external data model described above in relation to operation 312 of FIG. 3A.

The system creates a first mapping of elements of the external data model to elements of an internal data model native to the network device (operation 504). The network device may, upon booting up its system, load a native internal YANG schema (as in operations 304 and 306 of FIG. 3A). The network device may generate an operational API for handling data using the loaded internal data model. The operational API may be used to save operational data in a database (e.g., Redis or another database). An extension in the internal YANG schema (also referred to as a “YANG extension”) may be used to identify how to save the operation data in the database. For example, a path to a Redis database may be included above in relation to the YANG extension used in the above-described internal data model.

The system creates a second mapping of the elements of the external data model to Protobuf data structures (operation 506). For example, the network device may determine, based on the first mapping (as described above in relation to Table 1), the corresponding internal YANG element for an external YANG element and subsequently determine, based on the second mapping (as described above in relation to FIG. 3B), the exact Protobuf data structure which corresponds to the external YANG element.

The system extracts the data from a database by traversing the hierarchical structure associated with the external data model based on the first mapping and the second mapping (operation 508). As described above in relation to operations 408-412 of FIG. 4A, the hierarchical structure may be represented by a tree, and each node in the tree may correspond to a specific data element in the current external YANG schema, such as a container, a list, or a leaf. Each node may hold values which need to be serialized as part of the Protobuf serialization method described herein. The network device may process each node based on its type as defined in the YANG schema. If the traversal is not complete (as in decision 406 of FIG. 4A), the system can obtain an API function based on the third mapping (as described above in relation to operation 408). For example, for a node defined as a leaf in the current external YANG schema, the network device can determine the corresponding DB API function for that leaf (e.g., one of the Write or Read operation types as described above in relation to Table 2) and retrieve the data from a database based on the obtained API function (as described above in relation to operation 410).

If the traversal is complete (as in decision 406 of FIG. 4A), the system obtains a Protobuf-formatted message by encoding the extracted data directly into serialized bytes while obviating compilation of the current YANG schema to a Protobuf descriptor file and to the Protobuf-formatted message (operation 510). For example, the network device may call a function such as “encode_yang_to_proto” (as described above in relation to the pseudocode for encoding the retrieved data as serialized bytes), which creates the Protobuf message, encodes each node in the YANG tree, and returns serialized bytes based on the Protobuf-formatted message. Furthermore, the network device may use a recursive function such as “encode_yang_node” (as described above in relation to operation 412 of FIG. 4A and the pseudocode) to encode all YANG nodes into a Protobuf-formatted message. The network device can also convert the value obtained from the recursive encoding of each node into a corresponding Protobuf type (based on, e.g., the second mapping described above in relation to FIG. 3B and the pseudocode).

The system transmits the Protobuf-formatted message to a network management system in response to completing the traversal (operation 512). The network management station may receive the Protobuf-formatted message, use a similar YANG schema and mappings to decode the Protobuf-formatted message, and use the decoded information to perform additional operations.

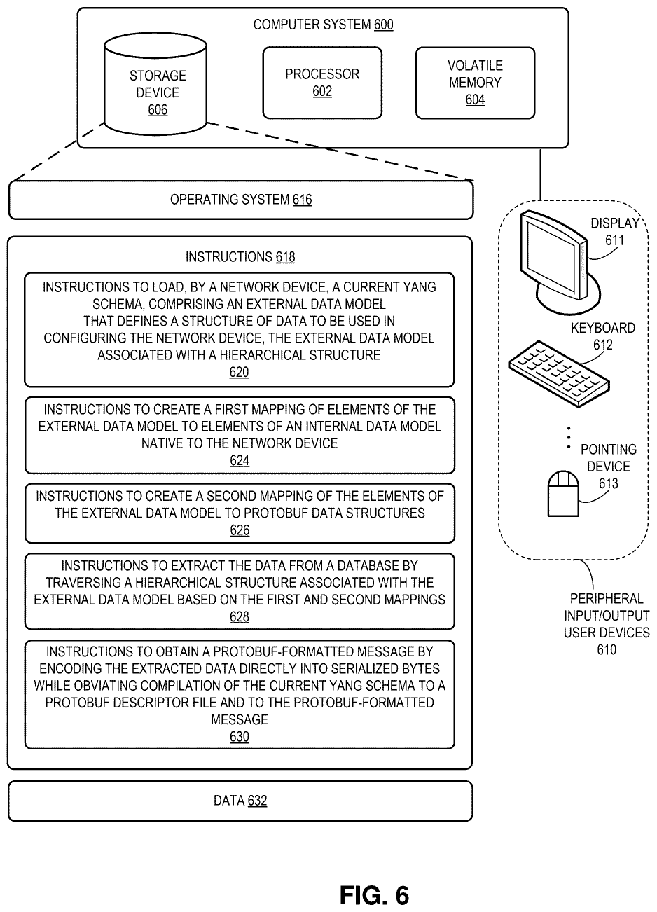

FIG. 6 illustrates a computer system 600 which facilitates a YANG schema-driven Protobuf serialization method, in accordance with an aspect of the present application. Computer system 600 includes a processor 602, a memory 604, and a storage device 606. Memory 604 may include a volatile memory (e.g., random access memory (RAM)) that serves as a managed memory and can be used to store one or more memory pools. Furthermore, computer system 600 may be coupled to peripheral I/O user devices 610 (e.g., a display device 611, a keyboard 612, and a pointing device 613). Storage device 606 includes non-transitory computer-readable storage medium and stores an operating system 616, instructions 618, and data 632. Computer system 600 may include fewer or more entities or instructions than those shown in FIG. 6.

Instructions 618, when executed by computer system 600, can cause computer system 600 to perform methods and/or processes described in this disclosure, e.g., including computer system 600 operating as an ingress network device. Specifically, instructions 618 may include instructions 620 to load, by a network device, a current YANG schema comprising an external data model that defines a structure of data to be used in configuring the network device, the external data model associated with a hierarchical structure, as described above in relation to operations 310 and 312 of FIG. 3A and operation 502 of FIG. 5.

Instructions 618 may include instructions 622 to create a first mapping of elements of the external data model to elements of an internal data model native to the network device, as described above in relation to operations 306 and 314 of FIG. 3A and operation 504 of FIG. 5.

Instructions 618 may include instructions 624 to create a second mapping of the elements of the external data model to Protocol Buffers (Protobuf) data structures, as described above in relation to operation 316 of FIG. 3A and operation 506 of FIG. 5.

Instructions 618 may include instructions 626 to extract the data from a database by traversing the hierarchical structure associated with the external data model based on the first mapping and the second mapping. A method for traversing the hierarchical structure is described above in relation to FIG. 4A and operation 508 of FIG. 5. An exemplary post-order traversal of a tree data structure is described above in relation to FIG. 4B.

Instructions 618 may include instructions 628 to obtain a Protobuf-formatted message by encoding the extracted data directly into serialized bytes while obviating compilation of the current YANG schema to a Protobuf descriptor file and to the Protobuf-formatted message, as described above in relation to operation 412 of FIG. 4A and operation 510 of FIG. 5.

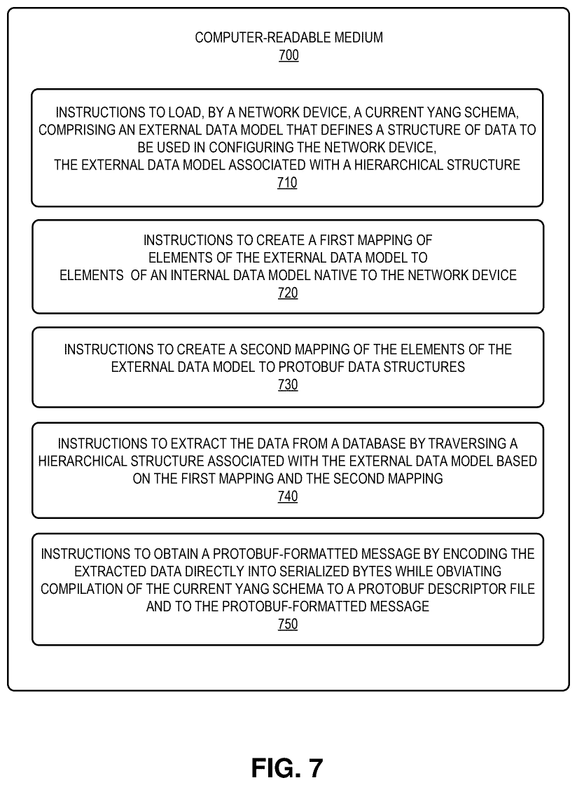

Instructions 618 may include more instructions than those shown in FIG. 6. For example, instructions 618 may include instructions for executing the operations described above in relation to: the diagram of FIG. 1; the communications of FIG. 2; the flowcharts and mappings of FIGS. 3A-3B and Tables 1-2; the pseudocode; the flowcharts of FIGS. 4A and 5; and the instructions of CRM 700 in FIG. 7.

Data 632 can include any data that is required as input or that is generated as output by the methods, operations, communications, and/or processes described in this disclosure. Specifically, data 632 can store at least: a current YANG schema; an updated YANG schema; a data structure; an external data model; an internal data model; a hierarchical structure; a first mapping of external data model elements to internal data model elements; a second mapping of external data model elements to Protobuf data structures; a Protobuf-formatted message; encoded data; extracted data; decoded data; serialized bytes; a YANG extension; an indicator of a list, container, or leaf elements in a YANG schema; an indicator of a repeated field, SubMessage, or scalar field in a Protobuf data structure; a third mapping of internal data model elements to corresponding database API functions; an indicator of a subscription for telemetry data; a result of traversing a hierarchical data structure; a post-order or depth-first traversal output; a notification of an updated YANG schema; and a request for an updated YANG schema.

FIG. 7 illustrates a computer-readable medium (CRM) 700 which facilitates a YANG schema-driven Protobuf serialization method, in accordance with an aspect of the present application. CRM 700 can be a non-transitory computer-readable medium or device storing instructions that when executed by a computer or processor cause the computer or processor to perform a method. CRM 700 may store instructions 710 to load, by a network device, a current YANG schema comprising an external data model that defines a structure of data to be used in configuring the network device, the external data model associated with a hierarchical structure, as described above in relation to operations 310 and 312 of FIG. 3A and operation 502 of FIG. 5.

CRM 700 may store instructions 720 to create a first mapping of elements of the external data model to elements of an internal data model native to the network device, as described above in relation to operations 306 and 314 of FIG. 3A and operation 504 of FIG. 5.

CRM 700 may store instructions 730 to create a second mapping of the elements of the external data model to Protocol Buffers (Protobuf) data structures, as described above in relation to operation 316 of FIG. 3A and operation 506 of FIG. 5.

CRM 700 may store instructions 740 to extract the data from a database by traversing the hierarchical structure associated with the external data model based on the first mapping and the second mapping. A method for traversing the hierarchical structure is described above in relation to FIG. 4A and operation 508 of FIG. 5. An exemplary post-order traversal of a tree data structure is described above in relation to FIG. 4B.

CRM 700 may store instructions 750 to obtain a Protobuf-formatted message by encoding the extracted data directly into serialized bytes while obviating compilation of the current YANG schema to a Protobuf descriptor file and to the Protobuf-formatted message, as described above in relation to operation 412 of FIG. 4A and operation 510 of FIG. 5.

CRM 700 may include more instructions than those shown in FIG. 7. For example, CRM 700 may also store instructions for executing the operations described above in relation to: the diagram of FIG. 1; the communications of FIG. 2; the flowcharts and mappings of FIGS. 3A-3B and Tables 1-2; the pseudocode; the flowcharts of FIGS. 4A and 5; and the instructions of computer system 600 in FIG. 6.

Thus, by providing specific mappings (e.g., a first mapping between external and internal data model elements, a second mapping between external data model elements to Protobuf data structures, and a third mapping between internal data model elements and database API functions), the described aspects allow a network device to dynamically adapt at runtime to changes and real-time updates to YANG schemas. The mappings and dynamic updates can result in a direct serialization of data into a Protobuf-formatted message, thus eliminating the need for intermediate compilation steps of the YANG schema to the Protobuf descriptor file and the Protobuf-formatted message. This approach can result in a significant improvement in flexibility and efficiency when handling changing network data models.

The term “network device” refers to any device, component, or computing entity which can provide a communication pipeline for packets sent from a “processing node” or an “endpoint node.” A processing or endpoint node can refer to a device, component, or hardware component which can operate as a source or a destination of data, including e.g., a control packet or a data packet. A network device may include an ingress network device, an intermediate or mid-fabric network device, or an egress or endpoint network device. An example of a network device may be a switch or a hardware-related component of a network device. A processing node or endpoint node can include an ingress node (which is an endpoint for data returned from a request) or an egress node (which is an endpoint for data sent from a request).

In general, the disclosed aspects provide a method, a computing system, and a computer-readable medium which facilitate a YANG schema-driven Protobuf serialization. During operation, the system loads, by a network device, a current YANG schema comprising an external data model that defines a structure of data to be used in configuring the network device, the external data model associated with a hierarchical structure. The system creates a first mapping of elements of the external data model to elements of an internal data model native to the network device. The system creates a second mapping of the elements of the external data model to Protocol Buffers (Protobuf) data structures. The system extracts the data from a database by traversing the hierarchical structure associated with the external data model based on the first mapping and the second mapping. The system obtains a Protobuf-formatted message by encoding the extracted data directly into serialized bytes while obviating compilation of the current YANG schema to a Protobuf descriptor file and to the Protobuf-formatted message.

In a variation on this aspect, creating the first mapping is based on a same YANG extension in the external data model and the internal data model.

In a further variation on this aspect, the system creates the second mapping of the external data model elements to the Protobuf data structures by: mapping a list element in the current YANG schema to a repeated field in a Protobuf data structure; mapping a container element in the current YANG schema to a SubMessage in the Protobuf data structure; and mapping a leaf element in the current YANG schema to a scalar field in the Protobuf data structure.

In a further variation, the system loads a native YANG schema comprising the internal data model. The system creates a third mapping of the elements of the internal data model to corresponding database API functions.

In a further variation, the system receives a subscription for telemetry data from a network management system. The system determines the data to be extracted based on the subscription.

In a further variation, the system traverses the hierarchical structure associated with the external data model based on the first mapping and the second mapping by performing the following operations iteratively prior to completing the traversal: obtaining an API function based on the third mapping; retrieving the data from the database based on the obtained API function; and encoding the retrieved data as serialized bytes assigned or appended to the Protobuf-formatted message.

In a further variation, the system transmits the Protobuf-formatted message to the network management system in response to completing the traversal.

In a further variation, the system receives a notification from a network management system that an updated YANG schema is available. The system requests the updated YANG schema from the network management system and receives the updated YANG schema from the network management in response to requesting the updated YANG schema. Loading the current YANG schema comprises loading the updated YANG schema.

In a further variation, prior to loading the current YANG schema, the system establishes a secure communication channel with a network management system. The system sends, over the secure communication channel, a request for the current YANG schema. The system receives, from the network management system, the current YANG schema in response to the request.

In another aspect, a computing system comprises a processing resource and a storage device storing instructions which when executed by the processing resource comprise instructions. The instructions are to load, by a network device, a current YANG schema comprising an external data model that defines a structure of data to be used in configuring the network device, the external data model associated with a hierarchical structure. The instructions are further to create a first mapping of elements of the external data model to elements of an internal data model native to the network device. The instructions are further to create a second mapping of the elements of the external data model to Protocol Buffers (Protobuf) data structures. The instructions are further to extract the data from a database by traversing the hierarchical structure associated with the external data model based on the first mapping and the second mapping. The instructions are further to obtain a Protobuf-formatted message by encoding the extracted data directly into serialized bytes while obviating compilation of the current YANG schema to a Protobuf descriptor file and to the Protobuf-formatted message. The computing system may also include additional instructions, including in relation to: the diagram of FIG. 1; the communications of FIG. 2; the flowcharts and mappings of FIGS. 3A-3B and Tables 1-2; the pseudocode; the flowcharts of FIGS. 4A and 5; and the instructions of CRM 700 in FIG. 7.

In yet another aspect, a non-transitory computer-readable medium storing instructions which when executed by at least one processing resource cause the at least one processing resource to perform a method. The system loads, by a network device, a current YANG schema comprising an external data model that defines a structure of data to be used in configuring the network device, the external data model associated with a hierarchical structure. The system creates a first mapping of elements of the external data model to elements of an internal data model native to the network device. The system creates a second mapping of the elements of the external data model to Protocol Buffers (Protobuf) data structures. The system extracts the data from a database by traversing the hierarchical structure associated with the external data model based on the first mapping and the second mapping. The system obtains a Protobuf-formatted message by encoding the extracted data directly into serialized bytes while obviating compilation of the current YANG schema to a Protobuf descriptor file and to the Protobuf-formatted message. The CRM may also store instructions for executing the operations described above in relation to: the diagram of FIG. 1; the communications of FIG. 2; the flowcharts and mappings of FIGS. 3A-3B and Tables 1-2; the pseudocode; the flowcharts of FIGS. 4A and 5; and the instructions of computer system 600 in FIG. 6.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computing-implemented method, comprising:
loading, by a network device, a current Yet Another Next Generation (YANG) schema comprising an external data model that defines a structure of data to be used in configuring the network device, the external data model associated with a hierarchical structure;
creating a first mapping of elements of the external data model to elements of an internal data model native to the network device;
creating a second mapping of the elements of the external data model to Protocol Buffers (Protobuf) data structures;
extracting the data from a database by traversing the hierarchical structure associated with the external data model based on the first mapping and the second mapping; and
obtaining a Protobuf-formatted message by encoding the extracted data directly into serialized bytes while obviating compilation of the current YANG schema to a Protobuf descriptor file and to the Protobuf-formatted message.

2. The method of claim 1, further comprising:
wherein creating the first mapping is based on a same YANG extension in the external data model and the internal data model.

3. The method of claim 1,
wherein creating the second mapping of the external data model elements to the Protobuf data structures comprises:
mapping a list element in the current YANG schema to a repeated field in a Protobuf data structure;
mapping a container element in the current YANG schema to a SubMessage in the Protobuf data structure; and
mapping a leaf element in the current YANG schema to a scalar field in the Protobuf data structure.

4. The method of claim 1, further comprising:
loading a native YANG schema comprising the internal data model; and
creating a third mapping of the elements of the internal data model to corresponding database Application Programming Interface (API) functions.

5. The method of claim 4, further comprising:
receiving a subscription for telemetry data from a network management system; and
determining the data to be extracted based on the subscription.

6. The method of claim 5, wherein traversing the hierarchical structure associated with the external data model based on the first mapping and the second mapping further comprises:
performing the following operations iteratively prior to completing the traversal:
obtaining an API function based on the third mapping;
retrieving the data from the database based on the obtained API function; and
encoding the retrieved data as serialized bytes assigned or appended to the Protobuf-formatted message.

7. The method of claim 6, further comprising:
transmitting the Protobuf-formatted message to the network management system in response to completing the traversal.

8. The method of claim 1, further comprising:
receiving a notification from a network management system that an updated YANG schema is available;
requesting the updated YANG schema from the network management system; and
receiving the updated YANG schema from the network management in response to requesting the updated YANG schema,
wherein loading the current YANG schema comprises loading the updated YANG schema.

9. The method of claim 1, wherein prior to loading the current YANG schema, the method further comprises:
establishing a secure communication channel with a network management system;
sending, over the secure communication channel, a request for the current YANG schema; and
receiving, from the network management system, the current YANG schema in response to the request.

10. A computing system comprising:
a processing resource; and
a storage device storing instructions which when executed by the processing resource comprise instructions to:
load, by a network device, a current Yet Another Next Generation (YANG) schema comprising an external data model that defines a structure of data to be used in configuring the network device, the external data model associated with a hierarchical structure;
create a first mapping of elements of the external data model to elements of an internal data model native to the network device;
create a second mapping of the elements of the external data model to Protocol Buffers (Protobuf) data structures;
extract the data from a database by traversing the hierarchical structure associated with the external data model based on the first mapping and the second mapping; and
obtain a Protobuf-formatted message by encoding the extracted data directly into serialized bytes while obviating compilation of the current YANG schema to a Protobuf descriptor file and to the Protobuf-formatted message.

11. The computing system of claim 10,
wherein the instructions to create the first mapping are based on a same YANG extension in the external data model and the internal data model.

12. The computing system of claim 10,
wherein the instructions to create the second mapping of the external data model elements to the Protobuf data structures are further to:
map a list element in the current YANG schema to a repeated field in a Protobuf data structure;
map a container element in the current YANG schema to a SubMessage in the Protobuf data structure; and
map a leaf element in the current YANG schema to a scalar field in the Protobuf data structure.

13. The computing system of claim 10, wherein the instructions are further to:
load a native YANG schema comprising the internal data model; and
create a third mapping of the elements of the internal data model to corresponding database Application Programming Interface (API) functions.

14. The computing system of claim 13, wherein the instructions are further to:
receive a subscription for telemetry data from a network management system; and
determine the data to be extracted based on the subscription,
wherein the instructions to extract the data from the database by traversing the hierarchical structure associated with the external data model based on the first mapping and the second mapping are further to perform the following operations iteratively prior to completing the traversal:
obtain an API function based on the third mapping;
retrieve the data from the database based on the obtained API function; and
encode the retrieved data as serialized bytes assigned or appended to the Protobuf-formatted message.

15. The computing system of claim 14, wherein the instructions are further to:
transmit the Protobuf-formatted message to the network management system in response to completing the traversal.

16. The computing system of claim 10, wherein the instructions are further to:
receive a notification from a network management system that an updated YANG schema is available;
request the updated YANG schema from the network management system; and
receive the updated YANG schema from the network management in response to requesting the updated YANG schema,
wherein the instructions to load the current YANG schema are further to load the updated YANG schema.

17. A non-transitory computer-readable medium storing instructions which when executed by at least one processing resource cause the at least one processing resource to perform a method, the method comprising:
loading, by a network device, a current Yet Another Next Generation (YANG) schema comprising an external data model that defines a structure of data to be used in configuring the network device, the external data model associated with a hierarchical structure;
creating a first mapping of elements of the external data model to elements of an internal data model native to the network device;
creating a second mapping of the elements of the external data model to Protocol Buffers (Protobuf) data structures;
extracting the data from a database by traversing the hierarchical structure associated with the external data model based on the first mapping and the second mapping; and
obtaining a Protobuf-formatted message by encoding the extracted data directly into serialized bytes while obviating compilation of the current YANG schema to a Protobuf descriptor file and to the Protobuf-formatted message.

18. The non-transitory computer-readable medium of claim 17, wherein creating the second mapping of the external data model elements to the Protobuf data structures comprises:
mapping a list element in the current YANG schema to a repeated field in a Protobuf data structure;
mapping a container element in the current YANG schema to a SubMessage in the Protobuf data structure; and
mapping a leaf element in the current YANG schema to a scalar field in the Protobuf data structure.

19. The non-transitory computer-readable medium of claim 17, the method further comprising:
loading a native YANG schema comprising the internal data model;
creating a third mapping of the elements of the internal data model to corresponding database Application Programming Interface (API) functions;
receiving a subscription for telemetry data from a network management system; and
determining the data to be extracted based on the subscription.

20. The non-transitory computer-readable medium of claim 19, wherein extracting the data from the database by traversing the hierarchical structure associated with the external data model based on the first mapping and the second mapping comprises:
performing the following operations iteratively prior to completing the traversal:
obtaining an API function based on the third mapping;
retrieving the data from the database based on the obtained API function; and
encoding the retrieved data as serialized bytes assigned or appended to the Protobuf-formatted message.
